(19) United States
(12) Patent Application Publication
(10) Pub. No.: US 2022/0009154 A1
(43) Pub. Date: Jan. 13, 2022

(54) Tape Winding Apparatus and Method

(71) Applicant: Pipeline Technique Limited, Huntly, Aberdeenshire (GB)

(72) Inventors: Ian Pibworth, Huntly. Aberdeenshire (GB); Anthony Davidson, Maghull, Liverpool (GB); Robert William Flannery, Hartlepool (GB)

(21) Appl. No.: 17/294,223

(22) PCT Filed: Jun. 25, 2019
(86) PCT No.: PCT/GB2019/051786

§ 371 Date: May 14, 2021

(30) Foreign Application Priority Data
Nov. 16, 2018 (GB) 1818735.1

(51) Int. Cl. B29C 63/10; B65H 81/00; F16L 13/02; F16L 58/16; F16L 58/18; F16L 58/10

(52) U.S. Cl. CPC B29C 63/10; B65H 81/00; F16L 58/1063; F16L 58/16; F16L 58/181; F16L 13/0272

(57) ABSTRACT

A tape winding apparatus (1) for winding a tape around a cutback between two factory coated, welded pipes to form a field joint coating, the apparatus comprising a housing (2) having first and second ends and adapted to be mounted over or around the cutback, a tape cassette (62) rotatably mounted within the housing and means (120, 44, 80) for linearly driving the cassette through the housing from a first position adjacent a first end of the housing to a second position adjacent the second end of the housing, a heat source (70) mounted on the cassette for directing heat towards one end of the cutback and the tape as it is wound onto the pipe, and further comprising an additional heat source (150) mounted within the housing adjacent the second end of the housing for directing heat towards the other end of the cutback.

This invention relates to a tape winding apparatus for wrapping a tape, and more specifically a thermoplastic tape as part of a multi-layer coating system to a pipe. More specifically the tape is applied to the bare metal cutback known as a field joint. of a pair of pipes joined end to end (known as a girth weld), particularly but not exclusively within the oil and gas or irrigation industries. The invention also relates to a method of winding or wrapping a tape around such a pipe or joined pipes and more specifically provides a method in which the tape is mechanically applied and temperature assisted during the winding or wrapping application.

### BACKGROUND

Typical pipeline fabrication uses long lengths of metal pipe, which can be around 12 meters in length, fabricated into a continuous pipeline by joining each length of pipe end to end. Each length of pipe is coated with a specific coating, the characteristics of which is dependent upon the intended use or location of the pipeline being laid. For example, a pipeline that is laid onshore and above ground to carry water for irrigation may require a relatively simple coating to protect the pipe against corrosion and damage whilst a pipeline laid offshore, many hundreds or even thousands of feet underwater, will require a complex coating fabricated from multi layers to provide, for example, thermal protection to the pipeline from the fluids flowing through the pipeline, structural protection against the high pressures resulting from the surrounding seawater and weighted coatings to ensure that the pipeline remains table on the seabed.

A typical multi-layer coating may consist of an anti-corrosion layer, for example a fusion bonded epoxy (FBE) applied to the outer surface of the pipe, a thermoplastic adhesive layer applied over the FBE and a thermoplastic outer layer applied over the adhesive layer. The adhesive layer bonds the outer layer to the FBE coating. The outer layer of the multi-layer coating is selected dependent upon the location and pipeline function and additional outer layers such as additional layers of thermoplastic materials, solid or syntactic foam and concrete weight coatings may be required.

The multi-layer coatings are typically applied in a factory environment. Each length of pipe is coated in this way except for the extreme ends of the pipe which are left bare. The bare ends are typically less than 500 mm in length and are referred to in the industry as cutbacks. Cutbacks are necessary in order to enable one pipe length to be joined to another pipeline length, for example by a welding process, without having to join one end of the multi-layer coating to the end of the multi-layer coating of a subsequent length of pipe, as this would require the bonding of multiple layers and different materials together which would inevitably create potential weak spots in the pipeline which fluids flowing in the pipeline could escape into the surrounding environment, or alternatively seawater in the surrounding environment to find a point of ingress into the pipeline leading to corrosion and leakage along the length of the pipeline.

The fabrication of such pipelines is undertaken in many locations globally which include, but are not limited to, onshore locations such as landlines, spoolbases or multijoining facilities as well as offshore fabrication on S-lay or J-lay or reel lay installation vessels.

During fabrication of the pipeline, the exposed and uncoated end of a first pipe length is welded to the exposed and uncoated end of a subsequent pipe length forming a cutback of up to around 1000 mm between the joined ends of the pipe. Once the pipe lengths are welded together, the cutback area of the joined pipes must be covered with a suitable material in order to provide protection to the cutback and restore integrity to the coating of the pipeline. Such a coated or covered cutback is referred to as a field joint. The field joint comprises the bare metal cutback on either side of the weld as well as the overlap area onto the parent coating which overlap area extends typically less than around 100 mm on each side of the field joint.

Typically, a field joint will comprise an anti-corrosion coating to protect the underlying metal of the cutback from corrosion, cathodic protection systems may also be used to protect the cutback area. Such an anti-corrosion layer can reduce the power requirements of a corrosion protection system significantly, for example up to 90%. The outer layers of the field joint provide mechanical protection for the anti-corrosion layer as well as a barrier to moisture and contaminate which could accelerate the corrosion process and lead to failure of the pipeline.

Known methods of forming a field joint to the cutback of a welded pipe include induction heating of a pipe and applying a layer of fusion bonded epoxy with a polyolefin adhesive, followed by winding a polyolefin tape helically over the coated cutback and the ends of the multi-layer parent coating. The tape is pre-heated and applied at an elevated temperature and hot air blowers are used to maintain a level of heat in the tape during the winding process. The hot air blowers are directed to the first end of the cutback and apply heat only at that end. The blowers follow the tape as it is applied, assisting its application and assisting adhesion to the cutback. Latent heat rising through the parent coating from the steel pipe is relied upon for completing the second end of the cutback. If necessary, a gas torch many be used to apply direct heat to the second end after the tape is applied.

An alternative known method is to apply a heat shrink sleeve comprising a thermoplastic sheet with residual tension over cutback. The bare metal cutback is firstly coated with an anti-corrosion coating, which is typically a liquid epoxy. The thermoplastic sheet has an adhesive layer on the underside and this sheet is placed loosely onto the coated cutback extending over the ends of the parent coating on each side of the cutback. The sheet is then heated to release the residual tension, thereby shrinking the sheet onto the cutback to form the field joint. At the longitudinal interface of the sheet, a thermoplastic or mastic strip is placed over the sheet and the parent coating. Upon shrinking, the sleeve conforms to the contours of the pipeline thus forming the field joint.

Another known method is to use injection moulding to apply a molten polyolefin by means of an extruder, accumulator and use of a piston to inject the material into a heated mould. Alternatively, a liquid polymer may be injected by means of plural component liquid dispensing equipment into a flexible reusable mould.

A further known alternative is to accelerate granular polyolefin material through an ignited mixture of gas providing a high temperature flame. This process melts the polyolefin which is deposited on the surface of the fusion bonded epoxy anti corrosion layer applied to the cutback. This process is commonly known as flamespray.

Finally, it is known to extrude a polyolefin sheet in situ over the cutback by means of an extrusion device. This sheet is then wrapped around the field joint mechanically in multiple layers. Known as a cigarette wrap.

Whilst each of these known methods can produce a field joint which is capable of withstanding the elevated temperatures and pressures that can be associated with pipelines carrying oil and gas products, particularly those that are laid many hundreds or thousands of feet subsea, each also has inherent inefficiencies in relation to the time taken to form the field joint, the operation of the process, or the quality of the field joint that is formed.

For example, when applying a hot tape, as only the initial side of the factory applied coating overlap to which the tape is applied is preheated, the successful adhesion to the subsequent side of the overlap is dependent upon the residual heat rising through the pipe from the fusion bonded epoxy application and stored heat in the roll of tape.

When applying a heat shrink sleeve the quality of the end product is reduced as this method typically utilises a gas torch to pre heat the parent coating overlap. This methodology relies heavily on the operator's skill, areas of under heated or overheated (waxing) lead to loss of adhesion.

The injection moulding apparatus requires an extrusion device which has a very large footprint and therefore requires ancillary kit and large power requirements which makes this option a very difficult choice for an offshore process. Also, for the liquid injection moulding process, the system suffers from adhesion issues when bonding to the factory applied coatings and is dependent on particular liquids having physical properties that are not entirely suitable for the installation or service of a pipeline.

The flame spray methods discussed above are very time consuming and labour intensive and require highly skilled operators to provide an effective level of quality for the field joint.

The present invention therefore aims to provide an apparatus for applying a field joint coating around a bare metal cutback of a pipeline which overcomes or at least mitigates against the disadvantages of the above described systems.

It is a further aim of the present invention to provide an apparatus for applying a field joint coating that can be transported to a required location, either onshore or offshore, and operated to form an effective field joint at the point of use, therefore allowing for flexibility in relation to the pipe laying operation.

It is a further aim of the present invention to provide an apparatus for applying a field joint coating in a horizontal or a vertical application depending upon the pipe lay method required.

It is a further aim of the present invention to provide a method of applying a field joint coating which is more time and cost efficient than the previously described known methods.

### STATEMENTS OF INVENTION

According to one aspect of the present invention there is provided a tape winding apparatus for winding a tape around a cutback between two factory coated, welded pipes to form a field joint coating, the apparatus comprising a housing having first and second ends and adapted to be mounted over or around the cutback, a tape cassette rotatably mounted within the housing and means for linearly driving the cassette through the housing from a first position adjacent a first end of the housing to a second position adjacent the second end of the housing, a heat source mounted on the cassette for directing heat towards one end of the cutback and the tape as if is wound onto the pipe, the apparatus further comprising an additional heat source mounted within the housing adjacent the second end of the housing for directing heat towards the other end of the cutback.

Preferably the additional heat source is mounted on a rail within the housing.

Advantageously the additional heat source is slidably mounted on the rail.

Preferably the additional heat source is advanced along the rail by movement of the cassette through the housing.

Advantageously the drive means for driving the cassette through the housing comprises a lead screw extending from one end of the housing to the other.

Preferably the outer surface of the lead screw has a helical thread running from one end to the other.

Advantageously a nut is mounted on the cassette. Conveniently the nut has a threaded bore, the thread of which corresponds in pitch to the thread of the lead screw. Advantageously, the pitch of the threads of the lead screw and also the bore of the nut may be selected depending upon the desired final thickness of the field joint coating.

Advantageously the nut comprises two portions that can be selectively coupled around the lead screw.

Advantageously the ends of the housing have a substantially inverted U-shaped configuration.

Conveniently the housing comprises a frame extending between the ends of the housing.

Preferably doors are provided in an upper portion of the frame to provide access into the housing.

Advantageously the doors are hinged to the ends of the housing.

Preferably also the housing comprises arms at the lower end of the housing, which arms are moveable between an open position in which the apparatus can be lowered onto a pipe, and a closed position in which the arms move inwardly to support the lower edge of the pipe and to secure the housing around the pipe.

Advantageously rams are mounted on the housing for moving the arms between the open and closed positions.

Preferably the rams are pneumatic rams.

Conveniently means are provided for centring the apparatus on a pipe. Conveniently the centring means may comprise one or more rams mounted on the ends of the housing. Advantageously the rams can be extended to contact a pipe within the housing and to adjust the position of the apparatus relative to the surface of the pipe. Most preferably the rams are pneumatic rams.

Advantageously the apparatus further comprises a tape spool for mounting a thermoplastic tape upon the cassette.

Conveniently the tape will vary in length depending for example of upon the pipe diameter. Advantageously, the tape may also have a 30 to 45 degree bevel on the leading edge thereof.

Preferably the cassette further comprises means for applying a variable tension to the tape as it is unwound from the spool.

Advantageously the variable tension means comprises one or more tension rollers and or tension clutches.

Conveniently the heat sources comprise heaters. Advantageously the heaters may be hot air heaters, infra-red heaters, radiant heaters or gas torch heaters or a combination thereof.

Advantageously the apparatus may be encapsulated within an environmental control box.

Preferably the apparatus may further comprise a control panel to enable the operator to control the operation of the apparatus.

According to a further aspect of the present invention there is provided a method of forming a field joint over a cutback between the factory applied coatings of two welded pipes comprising the steps of applying a heat source to the first end of the factory applied coating at one side of the cutback, winding a thermoplastic tape onto the end of the factory applied coating at the first side of the cutback, advancing the tape and the heat source linearly along the pipe, over the cutback whilst wrapping the tape around the cutback and simultaneously applying a further heat source to the end of the factory applied coating at the second end of the cutback.

Advantageously the method ensures that the factory applied coating at the second end of the cutback is heated to the same temperature as the factory applied coating at the first end of the cutback.

The method further comprises the step of moving the further heat source away from the second end of the factory coating as the tape approaches the second end of the factory coating to allow the winding process to be completed unimpeded by the further heat source.

Advantageously the method further comprises pre-heating the tape to a temperature of around 130° C. to 220° C. depending upon the materials selected.

Preferably the method further comprises the step of heating the field joint area of the joined pipes to around 190° C. to 250° C.

### INTRODUCTION TO THE DRAWINGS

An embodiment of the present invention will be described with reference to the accompanying figures in which:

FIG. 1 is a schematic perspective view of a tape winding apparatus according to one aspect of the present invention, in an open position;

FIG. 2 is a schematic view of the outer assembly of the apparatus of FIG. 1, in an open position;

FIG. 3 is a schematic partial sectioned view of the outer assembly of FIG. 2 including the slipring assembly;

FIG. 4 is a schematic view of the rotating inner assembly shown in FIG. 1;

FIG. 5 is an enlarged view of the rear drive mechanism of the apparatus of FIG. 1;

FIG. 6 is an enlarged schematic view of and the heater disc assembly of the apparatus of FIG. 1;

FIG. 7a is a schematic view of the leadscrew nut assembly of the apparatus of FIG. 1;

FIG. 7b is an exploded view of the leadscrew nut assembly of FIG. 7a;

FIG. 8a is an enlarged schematic view of the cassette assembly of the apparatus of FIG. 1;

FIG. 8b is a rear view of the cassette assembly of FIG. 8a, and

FIG. 9 is an enlarged schematic view of a slipring door of the apparatus of FIG. 1.

### SPECIFIC DESCRIPTION

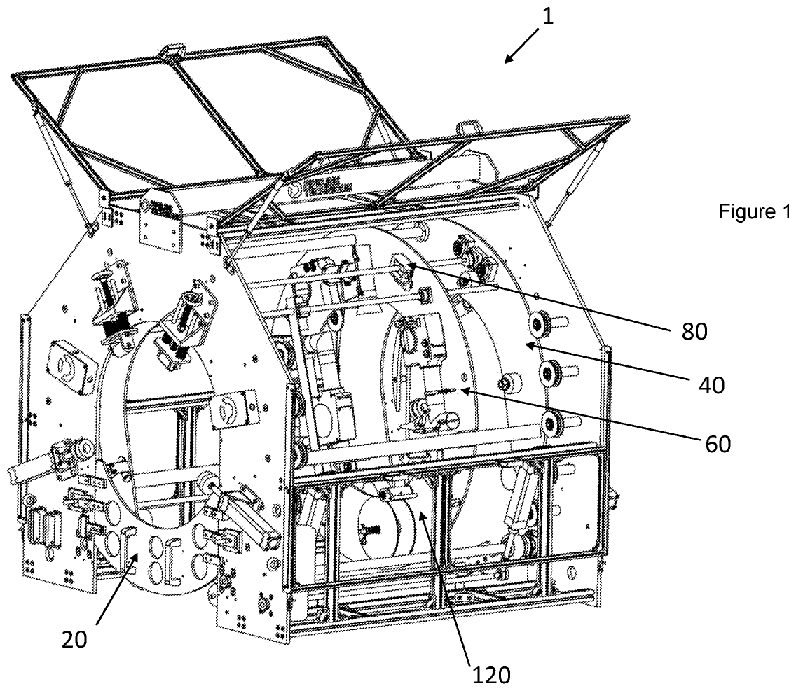

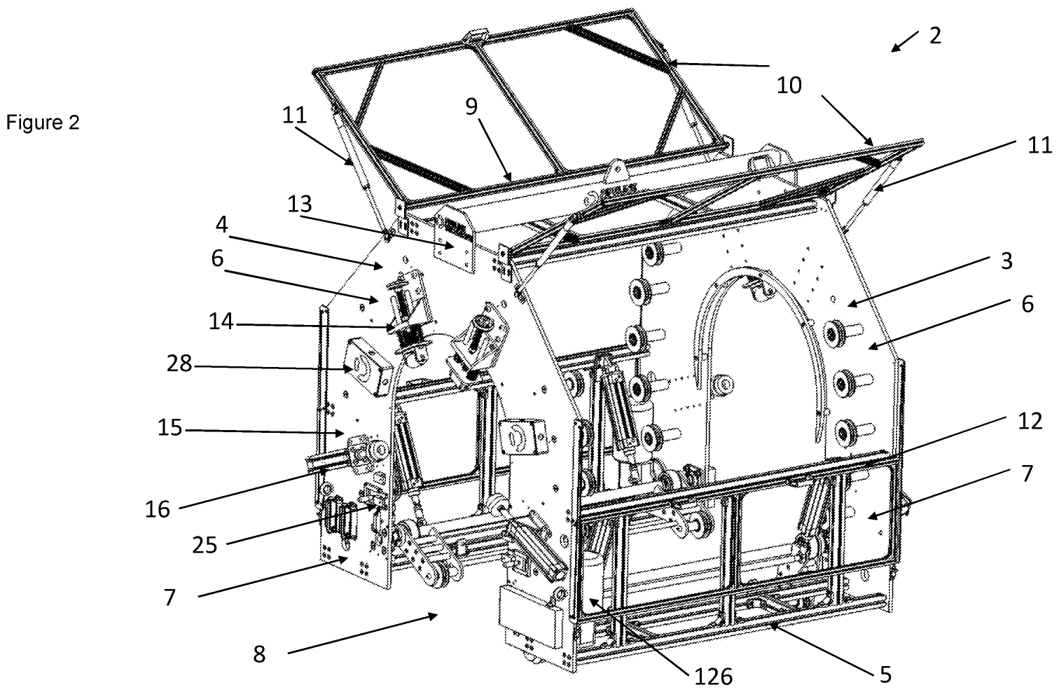

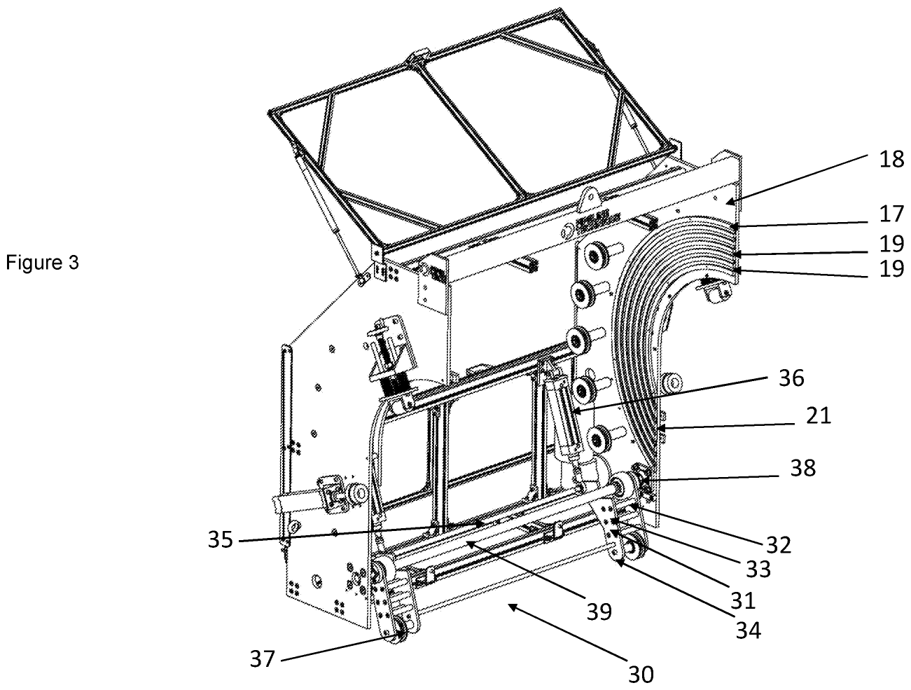

A tape winding apparatus 1 according to one embodiment of the present invention is shown in FIG. 1. The apparatus comprises an outer assembly or housing 2 which is shown in more detail in FIGS. 2 and 3 and has a substantially inverted U shaped configuration. The housing comprises two substantially U-shaped end plates 3,4 which are spaced apart by a frame 5. The end plates form the main support for mounting components of the apparatus and they form the main outer body of the apparatus. Each end plate has an upper portion 6 and side portions 7 that depend from the outer ends of the upper portion forming a channel 8 that extends through the frame 5 from the first end plate 3 at the first end of the housing to the second end plate 4 at the second or other end of the housing. The housing is sized such that the channel 8 can accept a pipe having a diameter of around 2 inches to 24 inches.

The frame 5 is formed of a number of structural elements 9 such as bars, rods or spars that span the distance between the two end plates 2,3. The upper portion of the frame comprises doors 10 that are mounted on a bar 9 which spans the space between the upper portion of the first end plate 3 and the upper portion of the second end plate 4. The ends of the bar 9 are hinged to the end plates 2 and 3 to allow the doors to open outwardly from the frame 5.

As shown in FIG. 1, actuators in the form of hydraulic or pneumatic cylinders or electrical actuators 11 may be connected between the upper portion 6 of each end plate 3, 4 and the respective door on each side of the housing to facilitate smooth operation of the doors between an open position as shown in FIG. 1 and a closed position. The doors allow an operator to gain access into the housing 2 as will be described further below and in the embodiment illustrated. One door is provided on each side of the upper portion of the housing.

A pair of doors 12 may also be provided in the lower part of the frame 5 as shown in FIGS. 1 and 2. The lower doors may be mounted to the frame in a similar manner as the upper doors described above.

Lights (not shown) may be mounted internally within the frame to assist an operator during operation of the apparatus.

A lifting beam 13 spans the apparatus from the centre of the upper portion 6 of the first end plate to the centre of the upper portion 6 of the second end plate and is used for lifting the apparatus either for operational or transport purposes. The lifting beam also adds strength and stiffness to the frame of the outer assembly.

As shown in FIG. 2, a pair of spring loaded shock absorbers 14 is mounted on the outer surface 15 of the end plate 4 at the second end of the housing. The shock absorbers are mounted on the upper portion 6 of the end plate and can be extended downwards towards the end of the channel 8 to position the apparatus centrally on a pipe as will be described further below.

A pair of pneumatic, electrical or hydraulic stabilizing rams 16 is provided, one on each of the side portions 7 of the end plates 3, 4. Each of the stabilizing rams is mounted about half way down the respective side portion 7 of the end plate and each can be extended inwards towards the end of the channel 8 to provide stability and prevent the apparatus from rotating around a pipe during operation as will be described further below.

As shown in FIG. 3, a portion of a slipring 17 is formed on the inner surface 18 of the end plate 4 at the second end of the housing. The portion of the slipring comprises a plurality of portions of concentric metal rings 19 which are set into a non-conductive material on the inner surface 18 of the end plate and are connected to an electrical supply as will be described further below.

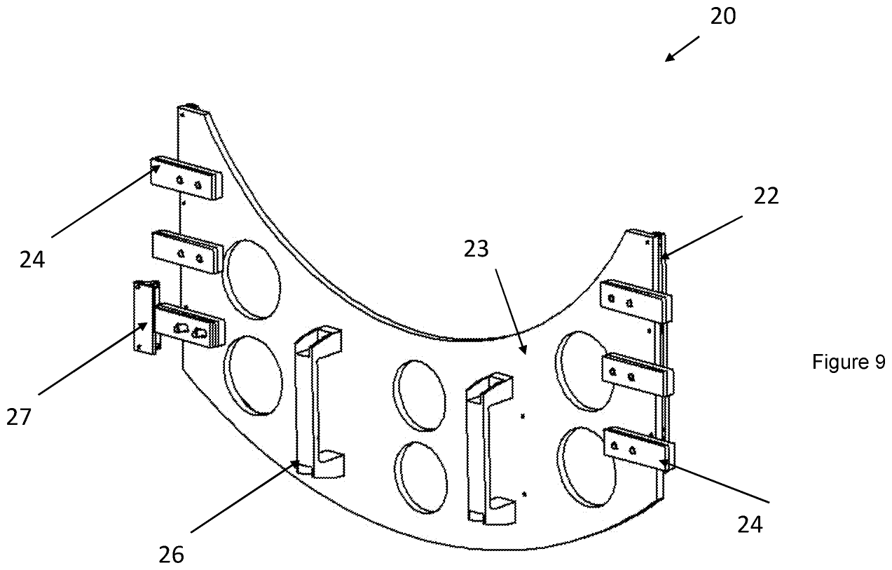

A removable arcuate element in the form of a slipring door 20 is mounted to the lower portion 21 of the end plate 4 upon which the slipring 17 is formed to close off the channel 8 through the housing. A more detailed view of the door is provided in FIG. 9. The element preferably comprises an arcuate aluminium plate to allow non-conductive materials to be mounted to the door. As shown in FIG. 9, a non-conductive plate 22 is mounted to the inner surface 23 of the slipring door to prevent the conduction of electricity by the door. The metal rings 19 of the slipring are not continued over the inner surface of the slipring door.

The slipring door may be latched or locked to the end plate by any suitable method. In the illustrated example extendible latches 24 and corresponding locking elements 25 for securing the latches are mounted on the end plate 4 and slipring door 20. The slipring door is shown in FIG. 1 in the latched or locked position on the end plate 4. The latches may be provided on the end plate or on the slipring door with the locking elements provided on the other.

The slipring door preferably has one or more handles 26 on the outer surface for aiding insertion or removal of the door from the outer assembly 2.

A door switch 27 is provided on the slipring door to sense when the slipring door 20 is mounted in position on the end plate 4 and ensure that electrical current is only passed through the slipring 17 when the door is secured in position.

A pair of electrical terminal boxes 28 are provided on the outer surface 15 of end plate 4 at the second end of the housing as shown in FIG. 2. These junction boxes transmit electrical power to the slipring assembly 17 described above.

A support wheel assembly 30 is mounted at the lower end of each side portion 7 on the inner surfaces 18 of end plates 3,4. Each support wheel assembly 30 is mounted on an edge of the side portion adjacent to the channel 8 through the housing. Details of the support wheel assemblies are shown in FIG. 3.

Each support wheel assembly 30 comprises a pair of substantial flat plates 31 spaced apart by a series of spars 32 shown in FIG. 3. Each plate has a substantially triangular portion 33 at one end closest to the end plate 3,4 with an extending longitudinal portion 34 at the end remote from the respective end plate. The flat plates 31 are rotationally mounted on a drive shaft 39 that runs from the first end plate 3 at the first end of the housing to the second end plate 4 at the second end of the housing. This drive shaft 39 is rotationally mounted to the end plates and maintains the spacing between the support wheel assemblies on each side of the housing.

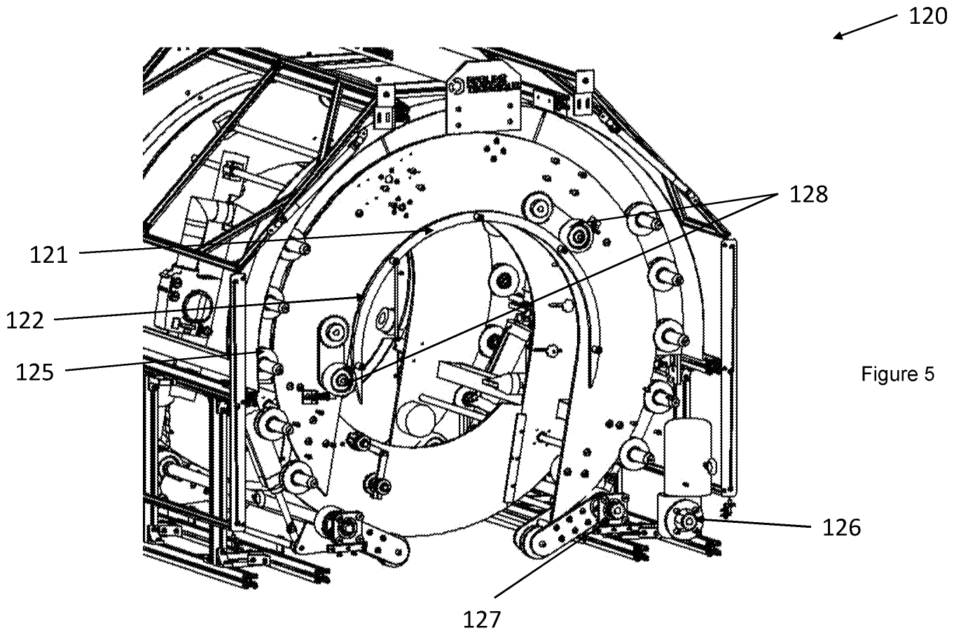

Pneumatic cylinders 36 are mounted to the frame 5 and are connected at the other end, via link bar 35 to each of the triangular portions 33 of the support wheel assemblies. Operation of the pneumatic cylinders has the effect of rotating the support wheel assemblies inwardly around the drive shaft from the position shown in FIG. 3 where the pneumatic cylinders 36 are retracted to the position shown in FIG. 5 where the pneumatic cylinders 36 are extended.

A disc or wheel 37 is rotatably mounted between the two flat plates 31 of each support wheel assembly 30. The wheel 37 is mounted upon the lowest spar 32 connecting the two flat plates of the support wheel assembly together and is freely rotatable around the spar.

A rubber wheel 38 is mounted at each end of the drive shafts such that driving of the shaft rotates the wheels. An adjustable bearing 38′ may be provided at each end of the drive shaft to allow the position of the rubber wheels to be adjusted as they wear during use.

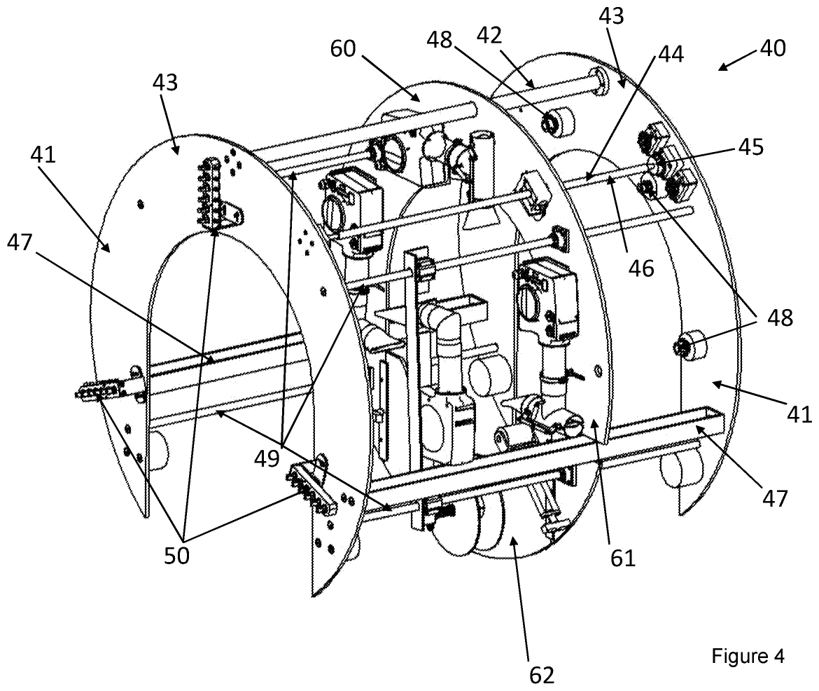

FIG. 4 illustrates the rotating inner assembly 40 of the apparatus of FIG. 1. The inner assembly comprises two flat substantially C-shaped discs 41. The discs provide support surfaces for carrying ancillary components of the apparatus. A torsion support bar 42 extends from the centre portion 43 of one of the discs to the centre portion of the other and keeps the discs at the correct spacing while providing torsional stiffness to the inner assembly.

A lead screw 44 is mounted within the inner assembly and extends from one C-shaped disc to the other. A keyed sprocket 45 is mounted on the lead screw 44 adjacent the inner surface of the first of the C-shaped discs. The outer surface of the leadscrew has a helical thread 46 which extends from one end of the leadscrew to the other.

A cable tray 47 extends between the inner surfaces of the two C-shaped discs 41 of the rotating inner assembly. Cable trays are provided on each side of the rotating inner assembly. These cable trays 47 provide an area for electrical cables to be safely housed while also adding stiffness to the rotating inner assembly.

Sprockets 48 are mounted on the inner surfaces of the first C-shaped disc 41 to provide mounting points for a drive system for rotating the lead screw 44 during operation of the apparatus as will be described further below. The sprockets 48 are mounted on shafts passing through the C-shaped discs. A chain (not shown) is provided for driving the keyed sprocket to rotate the lead screw 44. The chain passes over the sprockets 48 which are driven by a drive mechanism described below. The sizes of the keyed sprockets 45 and the chain sprockets 48 can be selected in order to achieve different tape overlap widths as will be described below.

Two pairs of linear guide rails 49 are provided between the two C-shaped discs 41. One pair is in the upper part of the assembly between the torsion support bar 42 and the cable trays 47 as will be described further below. The further pair is provided in the lower part of the assembly beneath the cable trays.

One or more slipring brush assemblies 50 is/are mounted on the outer surface of the second C-shaped disc 41. In FIG. 4, 3 such brush assemblies are shown. Each slipring brush assembly has an equal number of carbon brushes 51 to the number of metal rings 19 in the slipring 17. In a preferred embodiment, 6 such brushes are provided. The slipring brushes 51 contact the rings of the slipring to conduct the electrical current from the fixed outer assembly 2 to the rotating inner assembly 40. The brush assemblies 50 are spaced in such a way that 2 of the 3 brushes on each metal ring 19 are in contact at all times during rotation of the inner assembly 40 within the housing 2. This allows for safe transmission of the required current.

The rotating inner assembly 40 further comprises a travelling assembly 60 which is provided between the two C-shaped discs 41. The travelling assembly has a heater portion 61 with a similar C-shaped form to the C-shaped discs 41 and a cassette portion 62 which can be mounted to the heater portion and which comprises a flat arcuate plate. When the two portions 61,62 of the travelling assembly are assembled together, they form a flat annular disc as shown in FIG. 4.

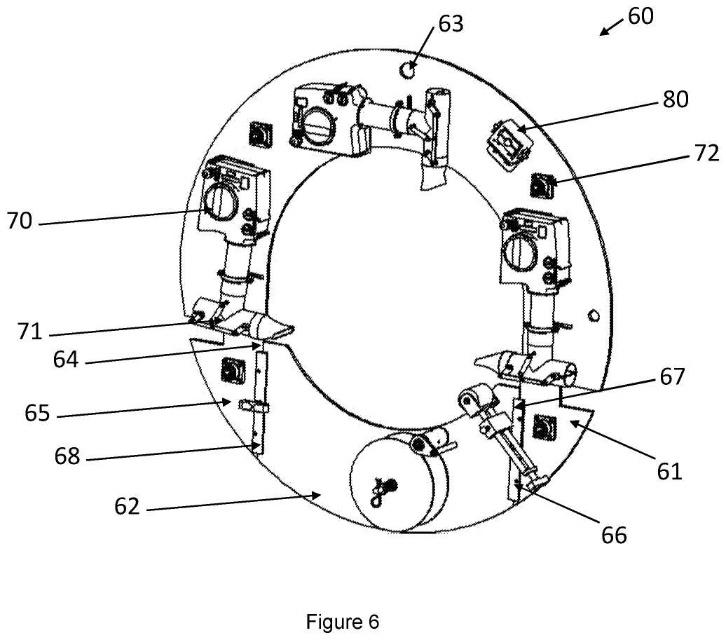

The travelling assembly is shown in more detail in FIG. 6. Apertures 63 in the heater portion 61 of the travelling assembly allow the leadscrew 44 and linear guide rails 49 to pass through the travelling assembly, however the linear guide rails are not fixed to the travelling assembly so the travelling assembly can move linearly between the two C-shaped discs 41 of the rotating inner assembly 40. Limit stops (not shown) may be provided to limit the linear movement of the travelling assembly and to keep the movement of the travelling assembly within the required range for the tape wrapping operation.

The inner edge 64 of each of the depending side portions 65 of the heater portion of the travelling assembly has a flat bar 66 mounted on either side of the edge, the flat bars 66 extending further than the edge 64 into the channel 8 of the housing. The flat bars have apertures 67 spaced along their length and similar apertures (not shown) are provided in the inner edge 64 of the side portions 65 of the travelling assembly. Fixing means 68 such as, for example screws or nuts and bolts pass through the apertures in the flat bars and the inner edge of the depending side portions of the heater portion to form a slot 69 between the flat bars 66.

A number of heaters 70 are mounted on the heater portion 61 of the travelling assembly 60. The heaters are preferably spaced around the surface of the heater portion on the side opposite to the first C-shaped disc 41 which is best shown in FIG. 6. In this configuration, the heaters will direct heat at three points on a pipe which are spaced approximately 90 degrees apart.

Each heater 70 has a nozzle 71 which can be adjusted to direct heat into the channel 8 within the frame as will be described further below. The nozzles may be any suitable shape for directing heat towards the channel 8 in the frame, for example round or square.

The heaters 70 may by any suitable heaters such as infra-red, radiant, hot air, gas torch for example.

The heater portion of the travelling assembly may be insulated to prevent or reduce transfer of heat from the heaters to the travelling assembly. A thermocouple (not shown) may be mounted to each heater 70 and connected to a control panel (not shown) to allow the operator to see real time information on the temperature of the heater. Warning lights (not shown) may be provided on the apparatus or a control panel to warn the operator of any heater failure.

As shown in FIG. 6, linear bearings 72 are mounted around the apertures 63 through which the linear guide rails 49 pass. These bearings allow the travelling assembly to move freely along the guide rails.

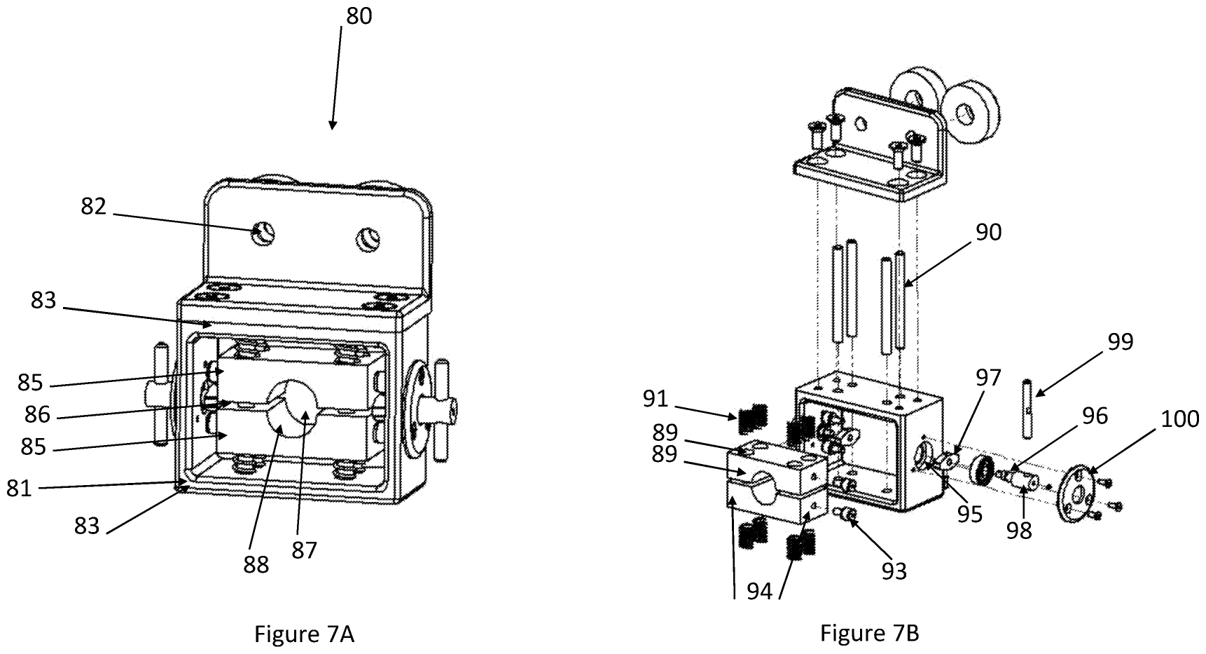

A disengaging lead screw nut 80 is mounted around the aperture 63 through which the lead screw passes. The disengaging lead screw nut is shown in more detail in FIGS. 7a and 7b and is used to move the travelling assembly 60 along the leadscrew 44 in a linear manner between the two C-shaped discs 41. The lead screw passes through the disengaging leadscrew nut such that rotation of the lead screw within the leadscrew nut results in movement of the leadscrew nut along the lead screw.

The disengaging lead screw nut comprises a housing 81 which has apertures 82 to allow the nut to be mounted to the first heater portion 61 of the travelling assembly. The housing is substantially rectangular with upper edges 83 lower edges 83′ and side edges 84. The nut is formed of upper and lower nut portions 85 which are mounted within the housing 81. The upper and lower portions 85 comprise rectangular bodies each with a substantially semi-circular recess provided in one edge 86. When the two nut portions are brought together, the edges 86 of the nut portions abut and the semi-circular recesses are lined up and define a bore 87 through the nut. The inner surface of the bore is threaded. The thread 88 matches the thread of the outer surface of the lead screw 44.

Each of the upper and lower portions of the nut 85 have cooperating bores 89 which extend through the upper and lower nut portions on either side of the threaded recesses. Guide rails 90 are mounted through the bores 89 to connect the upper and lower portions of the nut 85 together. Springs 91 are provided around the guide rails 90 between the upper and lower portions of the nut 85 and the inner surfaces 92 of the upper and lower edges 83, 83′ of the housing. The springs 91 push the upper and lower portions of the nut together.

A substantially circular boss or cam follower 93 is mounted on each end 94 of each upper and lower portions of the nut. An aperture 95 is provided through each of the side edges 84 of the housing 81. A short shaft 96 is provided on each side of the housing, passing through the aperture 95 in the side edges of the housing. The end of the shaft that terminates within the housing has an elliptical cam 97 mounted thereon. The elliptical cam 97 sits between the two cam followers 93 mounted on the ends of the upper and lower portions of the nut. The other end of the shaft terminating outside the housing has an axial bore 98 extending through the shaft and a handle 99 mounted in the bore. A circular faceplate 100 is fixed to the outer surface of the side edges 84 of the housing surrounding the aperture 95 and fixing the shaft 96 in position. Rotation of the shafts by turning the handles 99 turns the elliptical cam 97 which forces the two cam followers 93 to move apart thus pushing the upper and lower portions of the nut 84 apart and compressing the springs 91 against the inner surface of the upper and lower edges of the housing.

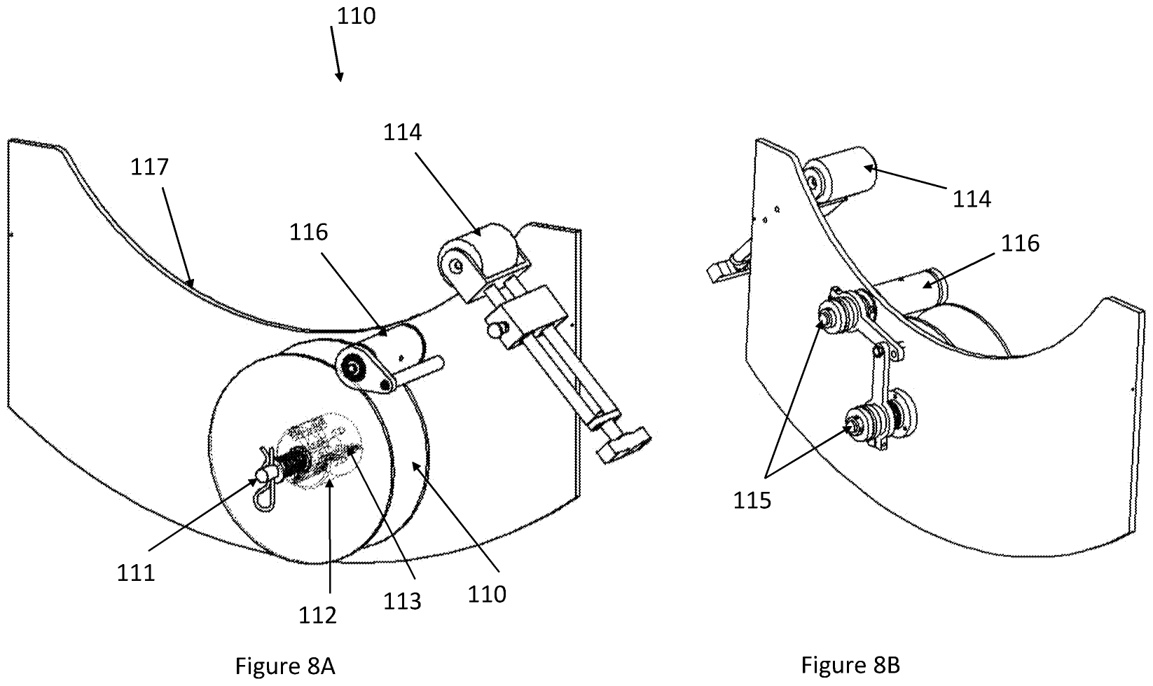

The cassette portion 62 of the travelling assembly comprises a flat arcuate plate that is sized to fit between the slots 69 on each side of the heater portion. The assembled travelling assembly 60 is shown in FIG. 6 and the cassette portion 62 is shown in more detail in FIGS. 8a and 8b.

The arcuate plate of the cassette portion carries a tape roll holder 110 which comprises a spar or spindle 111 that projects from the surface of the plate. A boss 112 is mounted around the spindle and the outer surface of the boss has a plurality of spring loaded blades 113 set therein. In the illustrated embodiment, 3 such blades are shown equispaced around the surface of the boss 112 but a different number may be provided. The blades overcome any irregularities in roll diameter and prevent slippage while under tension. A ghost line of a tape roll is shown in FIG. 8 on the tape roll holder.

A tension roller 114 is also be mounted on the arcuate plate adjacent to the spindle. The tension roller restricts the release of tape to a set degree and is adjustable to provide tension to a tape being dispensed from the roll during operation of the apparatus as will be described further below. Tension clutches 115 are mounted on the rear surface of the arcuate plate behind the tape roll holder 110 and tension roller 114 and each clutch is connected through apertures (not shown) in the arcuate plate to the respective one of the tape roll holder or tension roller. The tension clutches can be manually set to provide the required application tension to a tape.

A further roller 116 is mounted on the surface of the arcuate plate adjacent the tension roller. This further roller is operable to press the tape onto the pipe at the beginning of the application and can then be retracted once the tape has suitable self-adhesion. The further roller may preferably be spring loaded to the required force to allow such operation.

Both the tension roller 114 and further roller 116 are provided adjacent the inner curved edge 117 of the plate that will be closest to the pipe when the apparatus is assembled and in operation and directed towards the channel 8 through the apparatus.

As best shown in FIG. 6, when the arcuate cassette portion 62 is slide into position within the slots 69 of the heater portion, the travelling assembly 60 forms a substantially annular body within the frame of the apparatus.

Drive means 120 are provided within the frame to facilitate rotation of the rotating inner assembly 40 and movement of the travelling assembly 60 of the rotating inner assembly from a position adjacent the C-shaped disc 41 at one end of the rotating inner assembly towards the C-shaped disc 41 at the other end of the rotating inner assembly. The drive means is best shown in FIG. 5 which shows a view of the apparatus 1 from the first end of the housing with the U shaped end plate 3 shown in ghost lines for ease of reference. In this view the rotating inner assembly 40 is mounted in the outer assembly 2 and the cassette portion 62 is fixed to the heater portion 61 of the travelling assembly 60.

The drive means 120 comprises a drive ring 121 fixed to the inner surface 18 of U-shaped end plate 3. The drive ring 121 comprises a raised track 122 that is provided around the curved area of the end plate 3 which defines the upper portion of the channel 8 through the housing.

A plurality of guide rollers 125 are mounted on spindles 124 projecting from the inner surface 18 of end plate 3. The guide rollers 125 each have a circumferential groove within which the edge of the first C-shaped disc is received thus holding the disc in position within the housing.

A motor 126 is mounted at either end of the housing, internally of the lower portion of the end plates 2,3. The motors are mounted on opposite sides of the housing. FIG. 5 shows motor 126 mounted adjacent end plate 3. Motor 126′ is shown in FIG. 2 mounted adjacent end plate 4.

Motors 126 drive sprockets 127 which are keyed into the drive shafts 39. One sprocket is shown in FIG. 5 on one side of the housing and the other in FIG. 3 on the other side of the housing. As the sprockets turn the drive shafts 39 turn. As the motors and sprockets are on different sides of the housing, the drive shafts on each side of the housing turn in opposite directions. This rotates the rubber wheels 38 mounted on the drive shafts and in turn rotates the inner assembly via friction between the rubber wheels and the edge of the C-shaped discs 41.

A pair of wheel and sprocket assemblies 128 are mounted on the outer surface of the C-shaped disc 41 adjacent to the end plate 3. As shown in FIG. 5, two such wheel and sprocket assemblies are provided in this embodiment.

The wheel and sprocket assemblies roll along the drive ring 121 as the inner assembly rotates. Both of the wheel and sprocket assemblies 128 are connected via chain and sprockets to the guide shafts. These shafts are the same shafts that hold the keyed sprockets 48 mounted on the other side of the C-shaped disc, that dive the leadscrew via chain.

A tape spool (best shown in FIG. 8b) carrying a pre extruded tape of thermoplastics such as for example polypropylene, polyethylene, polystyrene, polymethyl methacrylate or any combination of polymer blend is provided which can be loaded into the housing and mounted on the tape roll holder 110.

In addition to the heaters 70 that are mounted on the heater portion 61 of the travelling assembly 60, an additional or chamfer heater 150 is mounted within the rotating inner assembly 40 between the travelling assembly 60 and the second C-shaped disc 41 of the rotating inner assembly. This additional heater 150 is mounted on an elongate bar 151 that has apertures 152 at each end to allow the bar to be slidably mounted on the linear guide rails 49 at the upper and lower ends at one side of the rotating inner assembly. The heater 150 is not connected to the travelling assembly 60 and can be moved independently of the position of the travelling assembly. The further heater 150 is not fixed in position on linear guide rails 49 but can be moved laterally along the guide rails 49 as will be described further below. The additional heater has a nozzle 153 that can be directed towards the channel 8 through the housing.

The operation of the tape winding apparatus described above will now be described.

Pipes having a suitable factory coating for the intended purpose and destination of the pipes are joined together using a known welding process. As described above, the factory coating does not extend over the ends of the pipe and therefore two joined pipes have a bare metal cutback section between the ends of the factory coating on one pipe and the start of the factory coating on the other pipe.

When it is required to form a field joint over a cutback section of two joined pipes, a spool of tape is selected having the required characteristics to form a field joint over the factory coating and the spool is mounted onto the tape roll holder 110 on the cassette portion 62 of the travelling assembly 60. As mentioned above, the blades 113 in the boss 112 of the tape holder ensures that the tape spool is centred on the holder. The tape as described above is a pre extruded tape of thermoplastic and is supplied in sufficient dimension to accommodate the project specific dimensions and material property requirements. The tape may be preloaded onto the spool and the tape may be stored at an elevated temperature around 130° C. to 220° C. prior to loading onto the cassette portion as described above. The temperature at which the tape is stored will be determined upon material selection and application requirements, but it is preferred that the tape is loaded into the spool shortly after extrusion so that the imparted residual stresses are congruent to the application methodology and subsequent performance.

The outer assembly 2 of the apparatus, is then moved into position above the cutback section of the pipe ends and lowered into position over the cutback, such that the cutback section of the pipe sits within the channel 8 of the apparatus. The motors 126 are engaged and drive the rubber wheels 38 in opposite directions. The rubber wheels contact the edge of the C-shaped discs 41 at each end of the rotating inner assembly and drive the inner assembly around within the housing.

The stabilizing rams 16 on each side portion of the end plates 3,4 are operated to extend inwards towards the channel 8 to contact the pipe. The rams are extended to a position where sufficient compression is applied against the surface of the pipes.

The spring loaded shock absorbers 14 also contact the outer surface of the pipe. In the event that the shock absorbers are not in contact with the outer surface of the pipe, the spring tension can be adjusted to bring them into the required position.

The support wheel assemblies 30 are engaged by extending the cylinders 36 and thereby rotating the support wheel assemblies inwards towards the channel 8 until the wheels 37 are in contact with the underside of the pipe as shown in the position of FIG. 5.

The slipring door 20 is fixed in position adjacent the end plate 4. The slipring door is locked in position by extending the latches 24 to their locked position within the locking elements 25.

With the outer housing secured around the pipe, the upper doors 10 on the frame of the housing allow access into the frame to assemble the travelling assembly 60.

When the upper doors 10 of the frame are open the rotating inner assembly 40 including the C-shaped discs 41, the travelling assembly 60 and the components mounted thereon can only rotate at a very slow RPM. A series of safety gate switches may be provided on the upper doors 10 which are designed to detect when the doors are open and an inverter drive specifically designed to work with safety gate switches may be used to control the operation.

In this position and with the rotating inner assembly 40 rotated such that that the slots 69 in the inner edges 64 of the side portions 65 of the heater portion are accessible through the open upper doors 10, the cassette portion 62 of the travelling assembly with the pre-loaded tape is mounted to the first heater portion 61 of the travelling assembly 60 and the fixing means 68 are tightened to ensure that the cassette portion is firmly held in position. At this stage, the travelling assembly fully surrounds the pipe.

Once the travelling assembly 60 is completed, the position of the travelling assembly is checked to ensure that it is located adjacent the C-shaped disc 41 at the first end of the housing, remote from the further heater 150 but at a position over the end of the factory coating on one side of the cutback. The position of the further or chamfer heater 150 is adjusted along the linear guide rails 49 rail upon which it is mounted such that this heater is directed at the end of the factory coating on the other side of the cutback. Thus, in this position, once the operation of the tape winding apparatus begins, both ends of the factory coating at either side of the cutback will be heated simultaneously during the tape winding operation.

The heaters 70 and 150 are switched on and the free end of the tape is released from the tape roll and placed onto the factory coating at one end of the cutback in the pipe and the roller 116 extended to apply pressure to the tape to ensure a good adhesion of the tape to the coating on the pipe. The pressure roller may then be lifted clear of the factor coating and locked in position during the remainder of the operation.

The doors 10 in the frame are then closed and the rotating inner assembly 40 is rotated at the required speed around the drive ring 121 on the end plate 3. As the inner assembly rotates, the key sprocket 45 turns the lead screw 44 which rotates within the lead screw nut 80. As the lead screw nut is fixed to the heater portion 61 of the travelling assembly 60, rotation of the lead screw 44 within the captive nut advances the nut along the thread 46 of the leadscrew thus moving the travelling assembly within the housing 2 from the first end towards the second end.

The hot tape is therefore wound onto the pipe starting from a position overlapping the factory coating one side of the cutback, across the cutback section and towards the factory coating on the other side of the cutback. The heaters 70 mounted on the cassette assembly 60 blow hot air or another heat source onto the tape prior, during and after application of the tape in order to keep the tape at the required application temperature to ensure a good bond between the tape, factory coating and field joint areas. The tension clutches 115 attached to the tension rollers 114 of the cassette portion 62 of the travelling assembly ensure that the tape has the required tension as it is wound onto the pipe.

The speed of rotation of the leadscrew and therefore the speed of linear movement of the travelling assembly through the housing can be controlled by the operator in order to ensure that the tape is wound onto the factory housing and over the cutback of the pipe with the required pitch and overlap for any specific job. Rotation of the leadscrew 44 and the consequential linear motion of the travelling assembly 60 through the housing are mechanically linked such that if the input speed is increased or reduced by the operator, both the rotational speed of the leadscrew and the linear speed of the travelling assembly will be reduced or increased proportionally. The input speed of the rotation of the leadscrew and or the pitch of the helical thread is determined by the required thickness of the tape to be wrapped on the field joint.

As the travelling assembly 60 moves through the housing 2 towards the second end of the housing, it approaches the position of the further heater 150 which has been providing a direct heating source to the other end of the factory coating remote from the end at which the tape wrapping begins. As the travelling assembly reaches the position of the further heater 150, this heater is pushed forwards by the travelling assembly along the guide rails 49 so that as the further heater 150 moves away from the surface of the second end of the factory coating to be covered. The continued forward movement of the travelling assembly 60 through the housing ensures that the hot tape is wound around the heated factory coating at the second end of the field joint with the heaters 70 on the cassette assembly applying the required localised heat to that section of the pipe in place of the further heater 150. This ensures that the second end of the cutback area remains at an elevated temperature until just prior to application of the hot tape at which point heat from the heaters 70 mounted on the travelling assembly 60 provide localised heat to that area.

Maintaining the second end of the cutback at an elevated temperature until just prior to the application of the tape ensures that the bond between the tape and the factory coating at the second end of the cutback is as secure and integral with the field joint as the first end and ensures continuity of the coating for the entire pipeline length.

Furthermore, by ensuring that the further heater 150 is moved automatically from a heating position by the movement of the travelling assembly 60, this allows the wrapping process to be completed unimpeded and at the desired temperature as there is no need to stop the wrapping process each time the position of the further heater 170 is reached which could lead to imperfections in the field joint which could allow the ingress of contaminants into the field joint.

Therefore, the integrity of each field joint formed during a coating process can be very precisely controlled and repeated from field joint to field joint along a pipeline.

Once the field joint is complete, the operation of the wrapping apparatus can be stopped and the tape severed if necessary from the tape remaining on the reel.

At the end of a tape wrapping operation, the travelling assembly 60 is located towards the second end of the housing closer to end plate 4. In order to reset the apparatus, the handles 99 on each side of the lead screw nut 80 are turned to turn the shafts 96 thus engaging the lobes of the elliptical cam 97 with the cam followers 93 on the ends 94 of the nut. This pushes the upper and lower portions 85 of the nut apart against the springs 91. In this position, the threads 88 on the inner surface of the bore 87 are disengaged from the threads 46 on the outer surface of the lead screw 44. This allows the travelling assembly to be pushed back along the leadscrew 44 towards the first end of the housing, ready for the next field joint to be coated.

If the lead screw nut was a regular nut always in threaded engagement with the lead screw 44, the only way to get the travelling assembly 60 back to its starting position would be to wind the leadscrew in the opposite direction to reverse the direction the nut travels along the lead screw. This would mean rotating the whole rotating inner assembly 40 many times in reverse which would be both time consuming and potentially detrimental to the operation and life of the apparatus. By providing a disengaging function for the lead screw nut 80 as described above, the travelling assembly 60 can be simply and quickly pushed back to the starting position for a subsequent tape winding application.

The slip ring door 20 mounted to the end plate 4 can be removed by retracting the latches 24 and releasing them from the locking elements 25 to allow access into the housing. The upper doors 10 of the housing can be opened as described above and the cassette portion 62 of the travelling assembly can be detached from the heater portion and removed through the open upper door.

The cylinders 36 are retracted to retract the support wheel assemblies 30 away from the underside of the pipe to allow the outer assembly to be lifted from the pipe in a reverse of the operation described above.

The apparatus can therefore be reset very quickly between wrapping one field joint and the next. Furthermore, as the inner assembly 40 of the apparatus rotates around the pipe being coated for multiple rotations, this allows the operation to be carried out in a very small space and would allow the apparatus to be used remotely in offshore locations for localised wrapping of field joints. It is envisaged that the apparatus would be used in both vertical and horizontal orientations depending upon the requirements at the installation location. This would allow the operator to selectively change the specification of the field joint to suit the specific conditions at the location where the pipe is being installed.

The apparatus as described above can be quickly and easily mounted on a pipe, operated and removed leaving a field joint covering the cutback of the pipe, where both ends of the field joint have been heated to the required temperature prior to and during the tape wrapping operation.

The tension rollers 114 mounted adjacent the spool of tape on the travelling assembly may be adjusted or selected in order to change the compressive force applied during the application of the tape. Oil filled rollers, spring or hydraulically mounted rollers or similar may be used to provide such adjustment to the tension of the tape as it is wrapped around the pipe.

The apparatus described can accommodate different pipe dimensions and it is envisaged that the apparatus would be operated by no more than two operators thereby providing cost and time efficiencies over known field joint coating methods.

These factors provide significant advantages over known tape winding devices and processes. In particular, the described apparatus and method is more cost efficient than known processes as the adhesion of the tape to the factory coating is improved and the adhesion is achieved chemically from the thermoplastic weld of the tape to the factory coating. The tape also requires less of an equipment footprint when compared to an extruder and significantly less energy to prepare. In addition, the tape can be stored on a reel without taking up much space. Additionally, the apparatus and method as described provides significant advantages over flamespray techniques as the quality of the bond is superior and the labour intensive and skilled application of the flamespray technique is avoided.

The illustrated embodiment describes an outer assembly which is open to the elements but it is envisaged that the entire outer assembly may be mounted within an environmental control box to provide for improved temperature control of the tape wrapping operation and to avoid dissipation of heat from the heaters 70, 150 away from the field joint area.

Whilst the operation above is described in terms of the outer assembly being placed over a pipe, it is of course possible that the outer assembly may be fixed in position and a pipe introduced through the outer assembly from one end to another, with successive field joints being coated as the welded pipe sections pass through the housing.

It is further anticipated that the tape may be pigmented in order to allow an operator to identify the required tape quickly from a number of stored tapes within a heated facility.

What is claimed is:

1. A tape winding apparatus for winding a tape around a cutback between two factory coated, welded pipes to form a field joint coating, the apparatus comprising a housing having first and second ends and adapted to be mounted over or around the cutback, a tape cassette rotatably mounted within the housing and means for linearly driving the cassette through the housing from a first position adjacent a first end of the housing to a second position adjacent the second end of the housing, a heat source mounted on the cassette for directing heat towards one end of the cutback and the tape as it is wound onto the pipe, and further comprising an additional heat source mounted within the housing adjacent the second end of the housing for directing heat towards the other end of the cutback.

2. A tape winding apparatus according to claim 1, wherein the additional heat source is slidably mounted on a rail within the housing.

3. A tape winding apparatus according to claim 2, wherein the additional heat source is movable along the rail by linear advancement of the tape cassette.

4. A tape winding apparatus according to claim 1, wherein the heat source mounted on the cassette comprises one or more heaters.

5. A tape winding apparatus according to claim 1, wherein the drive means for driving the cassette through the housing comprises a lead screw extending from one end of the housing to the other.

6. A tape winding apparatus according to claim 5, wherein the outer surface of the lead screw has a helical thread running from one end to the other.

7. A tape winding apparatus according to claim 5, wherein a threaded nut is mounted on the cassette, through which the leadscrew passes.

8. A tape winding apparatus according to claim 7, wherein the nut comprises two portions that can be selectively coupled around the lead screw.

9. A tape winding apparatus according to claim 1, wherein the outer ends of the housing have a substantially inverted U-shaped configuration.

10. A tape winding apparatus according to claim 1, wherein the housing comprises a frame extending between the ends of the housing.

11. A tape winding apparatus according to claim 10, wherein doors are provided in an upper portion of the frame to provide access into the housing.

12. A tape winding apparatus according to claim 1, wherein the housing comprises arms at the lower end of the housing, which arms are moveable between an open position in which the apparatus can be lowered onto a pipe, and a closed position in which the arms move inwardly to support the lower edge of the pipe and to secure the housing around the pipe.

13. A tape winding apparatus according to claim 1 further comprising means for centring the apparatus over or around a pipe.

14. A tape winding apparatus according to claim 1, wherein the tape cassette carries a spool of thermoplastic tape.

15. A tape winding apparatus according to claim 14, wherein the tape has a bevelled leading edge.

16. A tape winding apparatus according to claim 15 wherein the bevel on the leading edge of the tape is 30 to 45 degrees.

17. A tape winding apparatus according to claim 14, further comprising means for applying a variable tension to the tape as it is unwound from the spool.

18. A tape winding apparatus according to claim 17, wherein the variable tension means comprises one or more tension rollers and or tension clutches.

19. A tape winding apparatus according to claim 1, wherein the heat sources comprise any of hot air heaters, infra-red heaters, radiant heaters or gas torch heaters or a combination thereof.

20. A tape winding apparatus according to claim 1 further comprising a control panel to enable the operator to control the operation of the apparatus.

21. A method of forming a field joint over a cutback between the factory applied coatings of two welded pipes comprising the steps of applying a heat source to the first end of the factory applied coating at one side of the cutback, winding a thermoplastic tape onto the end of the factory applied coating at the first side of the cutback, advancing the tape and the heat source linearly along the pipe over the cutback whilst wrapping the tape around the cutback and simultaneously applying a further heat source to the end of the factory applied coating at the other side of the cutback.

22. A method of forming a field joint over a cutback between the factory applied coatings of two welded pipes according to claim 21 and further comprising the step of heating the end of the factory applied coating at the other side of the cutback to the same temperature as the first end of the cutback.

23. A method of forming a field joint over a cutback between the factory applied coatings of two welded pipes according to claim 21, further comprising the step of moving the further heat source away from the second end of the factory coating as the tape approaches the second end of the factory coating to allow the winding process to be completed unimpeded by the further heat source.

24. A method of forming a field joint over a cutback between the factory applied coatings of two welded pipes according to claim 21, further including the step of pre-heating the tape to a temperature of about 130° C. to 220° C.

25. A method of forming a field joint over a cutback between the factory applied coatings of two welded pipes according to claim 21, wherein the cutback is heated to about 190° C. to 250° C.
